(19) United States
(12) Patent Application Publication
(10) Pub. No.: US 2024/0401697 A1
(43) Pub. Date: Dec. 5, 2024

(54) SEALING DEVICE

(71) Applicant: DATA IMAGE CORPORATION, New Taipei City (TW)

(72) Inventors: Ching-Wen CHEN, New Taipei City (TW); Hsien-Kuan WANG, New Taipei City (TW); Hao-Yu CHUANG, New Taipei City (TW)

(73) Assignee: DATA IMAGE CORPORATION, New Taipei City (TW)

(21) Appl. No.: 18/382,563

(22) Filed: Oct. 23, 2023

(30) Foreign Application Priority Data
May 31, 2023 (TW) 112205482

(51) Int. Cl. F16J 15/10

(52) U.S. Cl. CPC F16J 15/104

(57) ABSTRACT

An sealing device for a display device is provided. The display device includes a display surface and an outer periphery surface. The sealing device comprises a base and a sealing ring component. The base has an inner side surface and an inner bottom surface. The sealing ring component is disposed in the base along the inner side surface. The sealing ring component is propped against the outer periphery surface without in contact with the display surface when the display device is arranged on the base, and then a to-be-evacuated space is formed between the display surface and the inner bottom surface.

This application claims the benefit of Taiwan application Serial No. 112205482, filed May 31, 2023, the disclosure of which is incorporated by reference herein in its entirety.

### TECHNICAL FIELD

The present invention relates in general to a sealing device and more particularly to a sealing device for a display device.

### BACKGROUND

The vacuum leak test is to detect whether an air leakage happens in a to-be-tested product. Generally speaking, when a to-be-tested product is arranged in a conventional jig for the vacuum leak test, a sealing component of the jig is usually in contact with a front surface of the to-be-tested product. If the front surface of the to-be-tested product is a display surface of a monitor, the sealing component may block a to-be-tested passage of the product, thereby being impossible to fully confirm the air leakage condition about the product. Alternatively, if the front surface of the to-be-tested product is the display surface of the monitor, the sealing component may cause pressure damage on the display surface of the monitor.

Accordingly, those skilled in the art are dedicated to achieve how to prevent negative situations about the vacuum leak test.

### SUMMARY

In view of the situations of the prior art, a new sealing device is provided in the present disclosure, and this sealing device is used for preventing a front surface of a to-be-tested product from being contacted during the vacuum leak test.

According to an aspect of the present disclosure, a sealing device for a display device is provided. The display device includes a display surface and an outer periphery surface. The sealing device comprises a base and a sealing ring component. The base has an inner side surface and an inner bottom surface. The sealing ring component is disposed in the base along the inner side surface. The sealing ring component is propped against the outer periphery surface without in contact with the display surface when the display device is arranged on the base, and then a to-be-evacuated space is formed between the display surface and the inner bottom surface.

The disclosure of the present invention will become apparent from the following detailed description of the preferred but non-limiting embodiments. The following description is made with reference to the accompanying drawings.

### BRIEF DESCRIPTION OF THE DRAWINGS

FIG. 1 illustrates a side sectional view of a sealing device and a display device that the sealing device is applicable to according to an embodiment of the present disclosure.

FIG. 2 illustrates a partial enlarged drawing of the sealing device and the display device that the sealing device is applicable to of FIG. 1.

FIG. 3 illustrates a side sectional view of arranging a display device on a sealing device according to an embodiment of the present disclosure.

FIG. 4 illustrates a partial enlarged drawing of the sealing device and the display device that the sealing device is applicable to of FIG. 3.

FIG. 5 illustrates a schematic diagram in a top view of a sealing device according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The embodiments of the present disclosure will be described more fully hereinafter with accompanying drawings. In addition to the detailed descriptions, the present invention can also be widely implemented in other embodiments. Simple substitution or modification and equivalent variation of any embodiment are included in scope of the present invention. A true scope of the disclosure is indicated by the following claims.

In description of the specification, many specific details are provided in order to enable readers to have a more complete understanding of the present invention. However, the present invention may still be implemented under some or all of these specific details being omitted. In addition, well-known step or element is not described in detail to avoid unnecessary limitation of the present invention. The same or similar elements in the drawings have the same or similar reference signs. It should be noted that the drawings are for only schematic purpose and do not represent actual size or quantity of components, unless otherwise specified.

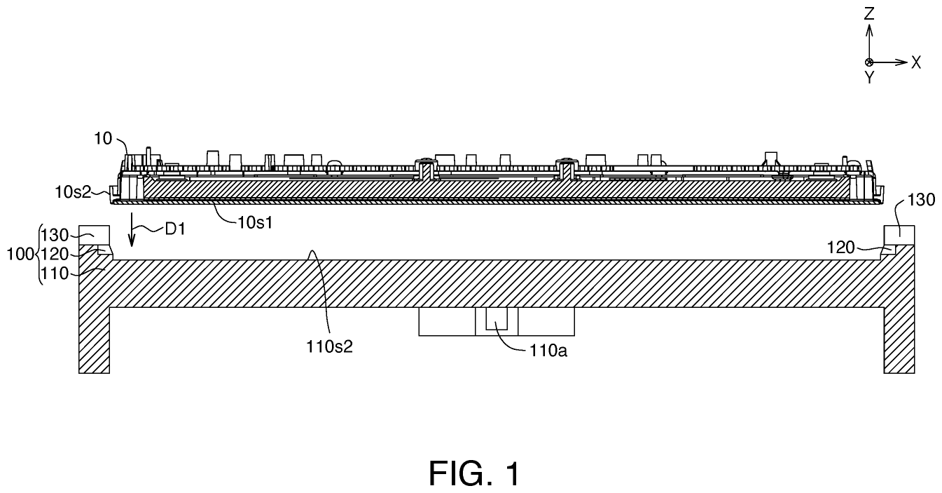

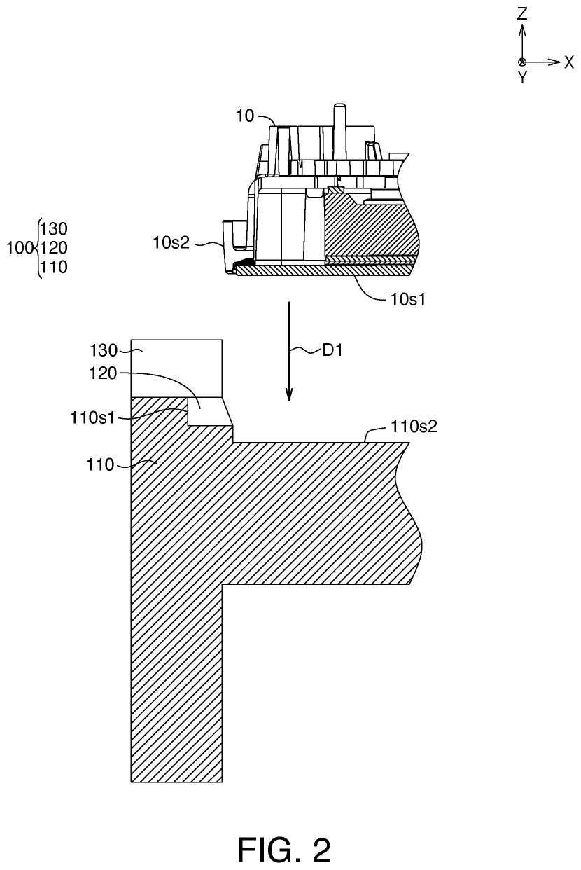

Please refer to FIG. 1 to FIG. 2, FIG. 1 shows illustrates a side sectional view of a sealing device 100 and a display device 10 that the sealing device 100 is applicable to according to an embodiment of the present disclosure, and FIG. 2 illustrates a partial enlarged drawing of the sealing device 100 and the display device 10 that the sealing device 100 is applicable to.

For example, the sealing device 100 according to an embodiment of the present disclosure is a sealing device applicable to the display device 10. The display device 10 is a display product such as a display of desktop computer, a display of tablet computer, or a navigation or aviation display. The sealing device 100 may be configured to form a to-be-evacuated space between the display device 10 and the display device 10, and then the to-be-evacuated space can be evacuated to a vacuum. As shown in FIG. 1 and FIG. 2, when a vacuum leak test is to be performed on the display device 10, the display device 10 can be installed on the sealing device 100 in the direction indicated by an arrow D1.

The display device 10 may include a display surface 10s1 and an outer periphery surface 10s2. The sealing device 100 may comprises a base 110 and a sealing ring component 120. The base 110 may have an inner side surface 110s1 and an inner bottom surface 110s2. For example, the sealing ring component 120 is a component for sealing, formed of a curing liquid adhesive material (such as a RTV curing liquid), a silicone material or a foaming material. The sealing ring component 120 may be disposed in the base 110 along the inner side 110s1 of the base 110. In addition, the sealing device 100 may further comprise at least one limiting component 130. For example, the limiting component 130 is a component for fixing, formed of a metal material or a plastic material. The limiting component 130 may be disposed on the sealing ring component 120 such that the sealing ring component 120 is positioned between the limiting component 130 and the base 110. The limiting component 130 may be configured to hold the sealing ring component 120 on the base 110 to prevent the sealing ring component 120 from separated from the base 110.

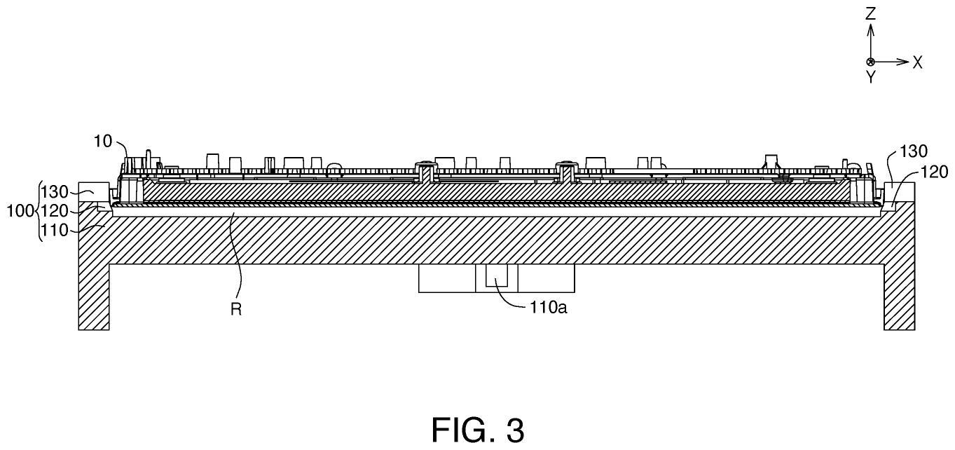

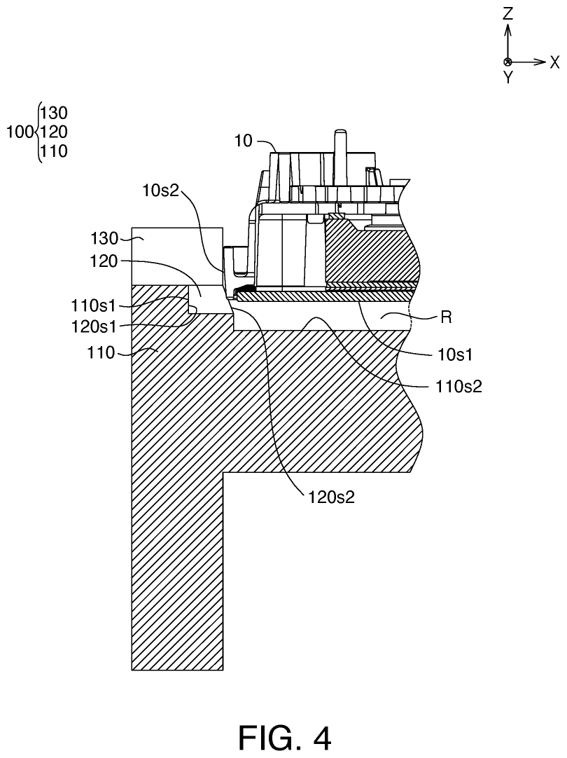

Please refer to FIG. 3 and FIG. 4, FIG. 3 illustrates a side sectional view of arranging the display device 10 on the sealing device 100, and FIG. 4 illustrates a partial enlarged drawing of the sealing device 100 and the display device 10 arranged thereon.

When the display device 10 is arranged on the base 110, the sealing ring component 120 is propped against the outer periphery surface 10s2 of the display device 10 without in contact with the display surface 10s1 of the display device 10, and then a to-be-evacuated space R is formed between the display surface 10s1 of the display device 10 and the inner bottom surface 110s2 of the base 110. The base 110 may have an air channel 110a. The air channel 110a may penetrate the inner bottom surface 110s2. That is, after the to-be-evacuated space R is formed between the display device 10 and the base 110, an air extraction device (not shown) can be connected to the air channel 110a to evacuate the to-be-evacuated space R to a vacuum, thereby performing a vacuum leak test of the display device 10.

As shown in FIG. 4, in a sectional view, a cross section of the sealing ring component 120 has a first edge 120s1 and a second edge 120s2 opposite to each other. A portion of the sealing ring component 120 corresponding to the first edge 120s1 is in contact with the inner side surface 110s1 of the base 110, and the outer periphery surface 10s2 of the display device 10 is propped against a portion of the sealing ring component 120 corresponding to the second edge 120s2. There is an interference fit between the outer periphery surface 10s2 of the display device 10 and the second edge 120s2 of the sealing ring component 120. The sealing ring component 120 may be slightly deformed due to an external force from the contact with the display device 10. Therefore, when the display device 10 is arranged on the base 110, an airtight contact is formed between the display device 10 and the second edge 120s2 of the sealing ring component 120 such that the air in the to-be-evacuated space R will not leak from the position where the sealing ring component 120 is in contact with the display device 10. Further, as shown in FIG. 4, when the display device 10 is arranged on the base 110, the outer periphery surface 10s2 of the display device 10 may be in contact with the limiting component 130. The contact between the outer periphery surface 10s2 and the limiting component 130 is for making the display device 10 more stably fixed on the sealing device 100, but this contact is not limited to be an airtight contact.

In the present embodiment, the first edge 120s1 and the second edge 120s2 are not parallel. Further, in the present embodiment, the two opposite edges of the sealing ring component 120 that are adjacent to the first edge 120s1 and the second edge 120s2 may be parallel. That is, the cross-section of the sealing ring component 120 in the present embodiment may be a trapezoidal shape. However, the present invention is not limited thereto. In other embodiments, the cross-section of the sealing ring component 120 may also be a rectangular (such as square or non-square rectangle) shape, a circular shape or other shapes. That is, the sealing ring component 120 may also be a rectangle-shaped ring or a circle-shaped ring.

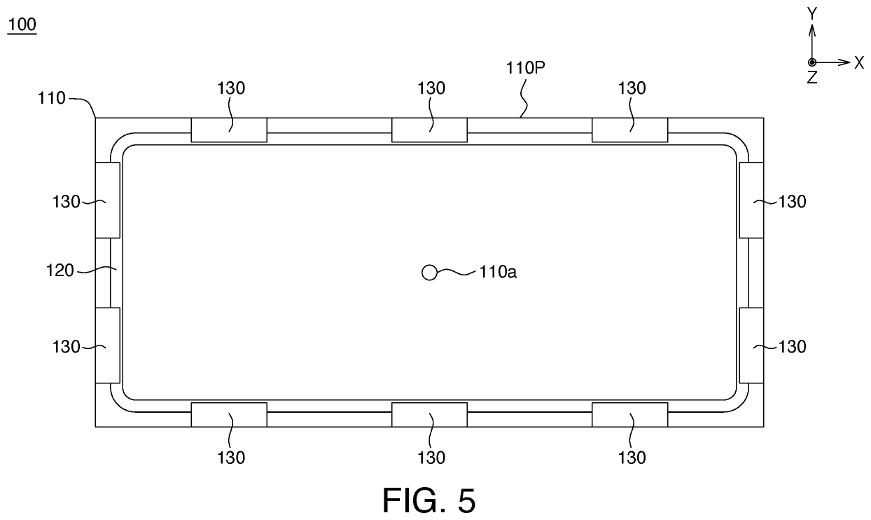

Please refer to FIG. 5, FIG. 5 illustrates a schematic diagram in a top view of the sealing device 100.

As shown in FIG. 5, in the present embodiment, the quantity of the at least one limiting component 130 is plural, and a plurality of limiting components 130 are spaced apart on the sealing ring component 120 along a periphery 110p of the base 110 (also the four edges of the base 110) such that the entire ring of the sealing ring component 120 can be uniformly limited and held. In addition, in a top view, the limiting component 130 and the sealing ring component 120 overlap at least partially with each other. However, the present invention is not limited to this. In other embodiments, the limiting component 130 is not limited to be a plurality of independent components spaced apart, but can be a single annular component that is formed integrally formed (namely formed in one piece), disposed on the sealing ring component 120, and at least partially overlapping with the sealing ring component 120 in a top view.

In conclusion, the sealing device 100 described in embodiments of the present disclosure can achieve that the sealing ring component will not be in contact with the display surface of the display device when a to-be-tested product as a display device is arranged on the base of the sealing device by the design of the sealing ring component with an improved cross-sectional shape. Therefore, the present invention can prevent a to-be-tested air channel from being blocked and avoid a pressure damage of a display surface of a display.

While the disclosure of the present invention has been described and illustrated with reference to specific embodiments thereof, these descriptions and illustrations do not limit the present invention. It should be understood by those skilled in the art that various changes may be made and equivalents may be substituted without departing from the true spirit and scope of the present invention as defined by the appended claims.

What is claimed is:

1. A sealing device for a display device, wherein the display device includes a display surface and an outer periphery surface, and the sealing device comprises:
a base, having an inner side surface and an inner bottom surface; and
a sealing ring component, disposed in the base along the inner side surface;
wherein the sealing ring component is propped against the outer periphery surface without in contact with the display surface when the display device is arranged on the base, and then a to-be-evacuated space is formed between the display surface and the inner bottom surface.

2. The sealing device according to claim 1, wherein in a sectional view, a cross section of the sealing ring component has a first edge and a second edge opposite to each other, and the first edge and the second edge are not parallel.

3. The sealing device according to claim 2, wherein a portion of the sealing ring component corresponding to the first edge is in contact with the inner side surface of the base.

4. The sealing device according to claim 2, wherein the outer periphery surface is propped against a portion of the sealing ring component corresponding to the second edge when the display device is arranged on the base.

5. The sealing device according to claim 3, wherein the outer periphery surface is propped against a portion of the sealing ring component corresponding to the second edge when the display device is arranged on the base.

6. The sealing device according to claim 1, wherein the base has an air channel, and the air channel penetrates the inner bottom surface.

7. The sealing device according to claim 1, further comprising at least one limiting component, and the at least one limiting component is disposed on the sealing ring component such that the sealing ring component is positioned between the at least one limiting component and the base.

8. The sealing device according to claim 7, wherein in a top view, the at least one limiting component and the sealing ring component overlap at least partially with each other.

9. The sealing device according to claim 7, wherein the quantity of the at least one limiting component is plural, and a plurality of limiting components are spaced apart on the sealing ring component along a periphery of the base.

10. The sealing device according to claim 8, wherein the quantity of the at least one limiting component is plural, and a plurality of limiting components are spaced apart on the sealing ring component along a periphery of the base.

11. The sealing device according to claim 1, wherein the sealing ring component is a rectangle-shaped ring or a circle-shaped ring.

12. The sealing device according to claim 1, wherein the sealing ring component is formed of a curing liquid adhesive material, a silicone material or a foaming material.
